(19) United States
(12) Patent Application Publication
(10) Pub. No.: US 2002/0170609 A1
(43) Pub. Date: Nov. 21, 2002

(54) Programmable logic controller apparatus, method, and modules

(76) Inventor: Derald J. Herinckx, Charlottesville, VA (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,663

(22) Filed: May 17, 2001

(51) Int. Cl. F16K 27/00

(52) U.S. Cl. 137/884

(57) ABSTRACT

A method for manufacturing a programmable logic controller (PLC) module includes mounting at least one valve inside the PLC module and positioning at least one outlet line in flow communication with the valve.

### BACKGROUND OF INVENTION

This invention relates generally to a programmable logic controller (PLC) and, more particularly, to modules for PLCs.

High purity gases are frequently utilized in manufacturing. Many gases, such as, for example, Nitrogen, Oxygen, and Argon are provided in bulk, and utilized in manufacturing processes. The processes are sometimes controlled by a PLC. Typically, the PLC includes a conventional electronic output module electronically connected to a conventional external valve assembly. However, a PLC in combination with an external valve assembly constitutes an enlarged system that occupies valuable space which otherwise can be used for other purposes.

### SUMMARY OF INVENTION

In one embodiment of the invention, a method for manufacturing a programmable logic controller (PLC) module includes mounting at least one valve inside the PLC module and positioning at least one outlet line in flow communication with the valve.

In another embodiment of the invention, a module for use with a programmable logic controller (PLC) including a base plate bus connector is provided. The module includes a module bus connector configured to operationally couple with the PLC. The module further includes a valve assembly connected to the module bus connector and controlled by the PLC.

In yet another embodiment of the invention, a module for use with a programmable logic controller (PLC) including a base plate bus connector includes a module bus connector configured to operationally couple with the PLC via the base plate bus connector. The module further includes a valve assembly connected to the module bus connector and controlled by the PLC. The valve assembly includes at least one valve, at least one inlet line in flow communication with the valve, at least one pneumatic line in flow communication with the valve, and at least one solenoid connected to the valve and controlled by the PLC.

### BRIEF DESCRIPTION OF DRAWINGS

FIG. 1 is a perspective view of two conventional PLC controlled valve systems.

FIG. 2 is a perspective view of one embodiment of a PLC controlled valve system including at least one valve module.

FIG. 3 is a cut away view of the PLC controlled valve system shown in FIG. 2.

### DETAILED DESCRIPTION

FIG. 1 is a perspective view of two conventional PLC controlled valve systems 10 including a hard wired valve system 12 and a network based valve system 14. Hard wired valve system 12 includes a mechanical valve unit 16 coupled to an input/output (I/O) module 18 of a programmable logic controller (PLC) 20. Valve unit 16 includes at least one inlet line (not shown), a manifold (not shown), and a plurality of outlet lines 22. The inlet line is in flow communication with the manifold and pressurizes the manifold. A solenoid-actuated valve (not shown) controls each outlet line 22 from the manifold. A direct current (DC) wiring harness 24 extends from I/O module 18.

Harness 24 includes a plurality of electrical wires (not shown) wherein each wire is connected to one of the solenoid-actuated valves. PLC 20 controls valve unit 16 by directing I/O module 18 to energize or de-energize the wires.

Network based valve system 14 include at least one intelligent valve unit 26 connected via a communications cable 28 to a communication module 30 of PLC 20.

Each valve unit 26 is electrically connected to a power source (not shown) and includes an inlet line (not shown), a manifold (not shown), and a plurality of outlet lines 32. The inlet line is in flow communication with the manifold and a solenoid-actuated valve (not shown) controls each outlet line 32 from the manifold. Each valve unit 26 further includes a network connection 34 for communication with communication module 30. Accordingly, PLC 20 controls the solenoid-actuated valves by directing communication module 30 to open and close the valves though the use of command signals sent from communication module 30 to network connections 34. However, both systems 12 and 14 occupy more space than PLC 20 due to the overhead of the separate valve units 16 and 26. Furthermore, valve unit 26 has the additional overhead of network connection 34.

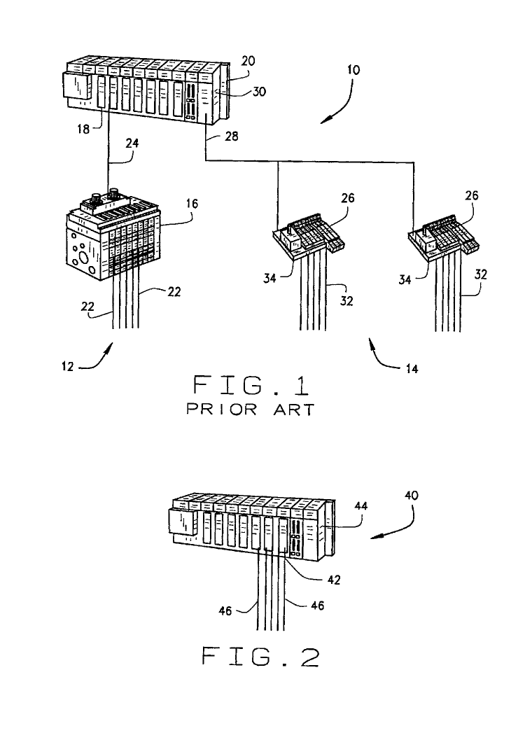

FIG. 2 is a perspective view of one embodiment of a PLC controlled valve system 40 including at least one valve module 42 operationally coupled to a PLC 44. At least one pneumatic line 46 extends from module 42. Accordingly, PLC controlled valve system 40 occupies less space than hard wired system 12 and networked system 14 (shown in FIG. 1).

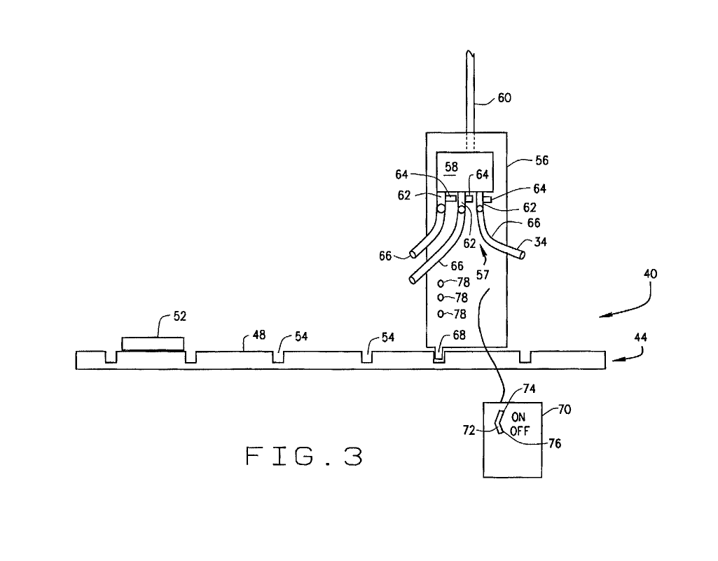

FIG. 3 is a cut away view of PLC controlled valve system 40 (shown in FIG. 2) including a base plate 48. A central processing unit (CPU) 52 is mounted to base plate 48. CPU 52 includes a programmable memory (not shown) for storing instructions to implement specific functions such as logic, sequence, timing, counting, and arithmetic to control machines and processes. Base plate 48 supplies inputs and outputs to CPU 52. PLC 44 can be a master PLC or a slave PLC. Base plate 48 includes a plurality of base plate bus connectors 54 for mounting various modules such as known I/O modules. In an exemplary embodiment, PLC 44 is a series 90-30 controller commercially available from the GE Fanuc Automation Corporation, Charlottesville, Va. A valve module 56 is mounted to one base plate bus connector 54. Valve module 56 includes a valve assembly 57 including a valve manifold 58 and an inlet line 60 extending to valve manifold 58.

Inlet line 60 is in flow communication with manifold 58. At least one valve 62 is in flow communication with manifold 58. In an exemplary embodiment, valves 62 are solenoid-actuated valves and are connected to at least one solenoid 64. At least one outlet line 66 is in flow communication with valves 62. In one embodiment, outlet lines 60 are pneumatic lines 46 (shown in FIG. 2). In another embodiment, outlet lines 60 are hydraulic lines. Valve module 56 further includes a module bus connector 68 for connecting module 56 to base plate 48. In an exemplary embodiment, module bus connector 68 is sized to mate with base plate bus connector 54, wherein module bus connector 68 and base plate bus connector 54 each include a plurality of electrical contacts (not shown) such that module bus connector 68 operationally couples to base plate bus connector 54 for communication between module 56 and PLC 44.

In an exemplary embodiment, a pendant control 70 extends from module 56. Pendant control 70 includes at least one selection device 72 to manually control at least one valve 62. Selection device 72 has an on position 74 and an off position 76. In one embodiment, selection device 72 is a toggle switch. In another embodiment, selection device 72 is a turn knob. In a further embodiment, selection device 72 is a push button. When PLC 44 is functioning, a user selects on position 74 to force valve 62 open overriding an off control signal generated by CPU 52. However, a selection of off position 76 will not force valve 62 closed if module 56 is receiving an on control signal from CPU 52. Accordingly, pendant control 70 acts as a partial manual override for controlling valves 62 when PLC 44 is functioning. Additionally, when PLC 44 is not functioning, pendent 70 control can be used to open and close valves 62. In other words, pendant control 70 controls valve 62, independently of PLC 44 when PLC 44 is not functioning.

During operation, a gas is in flow communication with inlet line 60 and pressurizes manifold 58. Outlet lines 66 are connected to various devices and PLC 44 controls delivery of the gas to the devices by controlling solenoids 64. Each solenoid 64 has a normal position (non-actuated) and a thrown position (actuated), wherein when an electromagnet (not shown) of solenoid 64 is energized, solenoid 64 is in the thrown position. Each valve 62 has an open position and a closed position, wherein the gas can flow through valve 62 when valve 62 is in the open position, and the gas can not flow through valve 62 when valve 62 is in the closed position. In an exemplary embodiment, when solenoid 64 is in the normal position, valve 62 is closed, and when solenoid 64 is in the thrown position, valve 62 is open. A user observes the process utilizing the gas and utilizes selection device 72 to open valves 62 when desired. In an exemplary embodiment, pendant control 70 includes a plurality of selection devices 72 that allows the user to selectively close a particular valve 62. In an exemplary embodiment, module 56 includes a plurality of indicator lights 78 corresponding to valves 62. Each light 78 is on when the corresponding valve 62 is open, and each light 78 is off when the corresponding valve is closed. Accordingly, the user receives a visual signal of each valve's 62 state. In one embodiment, module 56 includes at least one DC output (not shown) and an associated indicator light (not shown) is energized when the output is energized.

Valve module 56 is cost effective and facilitates reducing an amount of space occupied by a PLC based valve system. Accordingly, a PLC valve system utilizing a valve module such as module 56 occupies less space than system 12 and system 14 (shown in FIG. 1).

While the invention has been described in terms of various specific embodiments, those skilled in the art will recognize that the invention can be practiced with modification within the spirit and scope of the claims.

1. A method for manufacturing a programmable logic controller module, said method comprising the steps of:
mounting at least one valve inside the PLC module; and
positioning at least one outlet line in flow communication with the valve.

2. A method according to claim 1 further comprising the step of positioning a manifold in flow communication with the valve opposite the outlet line.

3. A method according to claim 2 further comprising the step of positioning an inlet line in flow communication with the manifold opposite the valve such that when the valve is open the inlet line is in flow communication with the outlet line.

4. A method according to claim 1 further comprising the step of attaching at least one pendent control to the module wherein the pendent control controls at least one valve.

5. A method according to claim 1 further comprising the step of mounting at least one indicator light inside the module.

6. A method according to claim 1 further comprising the step of mounting at least one indicator light inside the module, wherein the indicator light is on when the valve is open and the indicator light is off when the valve is closed.

7. A method according to claim 3 further comprising the step of mounting at least one indicator light inside the module, wherein the indicator light is on when the valve is open and the indicator light is off when the valve is closed.

8. A method according to claim 1 wherein said step of positioning at least one outlet line further comprises the step of positioning at least one outlet line comprising a pneumatic line in flow communication with the valve.

9. A module for use with a programmable logic controller (PLC) including a base plate bus connector, said module comprising:
a module bus connector configured to operationally couple with the PLC; and
a valve assembly connected to said module bus connector and controlled by the PLC.

10. A module in accordance with claim 9 wherein said module bus connector further configured to couple with the PLC via the base plate bus connector.

11. A module in accordance with claim 9 wherein said valve assembly comprises at least one valve.

12. A module in accordance with claim 11 wherein said valve assembly further comprises a manifold in flow communication with said valve.

13. A module in accordance with claim 12 wherein said valve assembly further comprises at least one inlet line in flow communication with said manifold.

14. A module in accordance with claim 9 wherein said valve assembly further comprises at least one outlet line in flow communication with said valve.

15. A module in accordance with claim 9 wherein said valve assembly further comprises at least one solenoid connected to said valve and controlled by the PLC.

16. A module in accordance with claim 13 further comprising a pendant control operationally coupled to said valve assembly.

17. A module for use with a programmable logic controller (PLC) including a base plate bus connector, said module comprising:
a module bus connector configured to operationally couple with the PLC via the base plate bus connector; and
a valve assembly connected to said module bus connector and controlled by the PLC, said valve assembly comprising:
at least one valve;
at least one inlet line in flow communication with said valve;
at least one pneumatic line in flow communication with said valve; and
at least one solenoid connected to said valve and controlled by the PLC.

18. A module according to claim 17 further comprising a pendent control operationally coupled to said valve, said pendent control comprising a selection device such that a user can utilize said selection device to open said valve overriding a close signal generated by said PLC.
